(19) United States
(12) Patent Application Publication
(10) Pub. No.: US 2023/0183947 A1
(43) Pub. Date: Jun. 15, 2023

(54) EXCAVATOR AND CONTROL METHOD THEREFOR

(71) Applicant: HYUNDAI DOOSAN INFRACORE CO., LTD., Incheon (KR)

(72) Inventors: Hansol KIM, Gwanak-gu, Seoul (KR); Youngsup LIM, Dong-gu, Incheon (KR); Wookhyun YU, Dong-gu, Incheon (KR); Seongho SONG, Dong-gu, Incheon (KR); Yoonhye KIM, Dong-gu, Incheon (KR); Changho LEE, Dong-gu, Incheon (KR)

(21) Appl. No.: 17/923,802

(22) PCT Filed: May 4, 2021
(86) PCT No.: PCT/KR2021/005618

§ 371 Date: Nov. 7, 2022

(30) Foreign Application Priority Data
May 7, 2020 (KR) 10-2020-0054724

(51) Int. Cl. E02F 9/26; E02F 9/24

(52) U.S. Cl. CPC E02F 9/26; E02F 9/24; E02F 3/32

(57) ABSTRACT

An excavator according to the present disclosure includes a display device, a control unit, a limit height setting unit, and a warning height setting unit. The display device displays shapes of a boom, an arm, and a bucket of an excavator and a terrain where the excavator is located. The control unit calculates maximum heights of the boom, the arm, and the bucket from the ground. The limit height setting unit is provided in the display device and is set with a limit height required for work in the terrain where the excavator is located by a user. The warning height setting unit is provided in the display device and is set with a warning height lower than the limit height. The display device displays the limit height and the warning height together with the terrain where the excavator is located.

### CROSS-REFERENCE TO RELATED APPLICATIONS

This application is the National Stage filing under 35 U.S.C. 371 of International Application No. PCT/KR2021/005618, filed on May 4, 2021, which claims the benefit of earlier filing date of and right of priority to Korean Application No. 10-2020-0054724 filed on May 7, 2020, the contents of which are all hereby incorporated by reference herein in their entirety.

### FIELD

The present disclosure relates to an excavator, and particularly, to an excavator capable of generating an alarm based on heights of a boom, an arm, and a bucket, and a control method therefor.

### BACKGROUND

In general, an excavator is a construction machine that performs work, such as excavation work for digging the ground, loading work for transporting soil, shredding work for dismantling buildings, and grading work for clearing the ground, at civil engineering, building, and construction sites.

### SUMMARY

The object of the present disclosure is to provide an excavator capable of generating an alarm based on heights of a boom, an arm, and a bucket, and a control method therefor.

In order to achieve the foregoing object, an excavator according to the present disclosure includes a display device, a control unit, a limit height setting unit, and a warning height setting unit. The display device displays shapes of a boom, an arm, and a bucket of an excavator and a terrain where the excavator is located. The control unit calculates maximum heights of the boom, the arm, and the bucket from the ground. The limit height setting unit is provided in the display device and is set with a limit height required for work in the terrain where the excavator is located by a user. The warning height setting unit is provided in the display device and is set with a warning height lower than the limit height. The display device displays the limit height and the warning height together with the terrain where the excavator is located.

According to an exemplary embodiment, the warning height is determined by user’s work tendency or a reaction speed of the excavator.

According to the exemplary embodiment, the display device displays the warning height to the user so as to be distinguished from the limit height.

According to the exemplary embodiment, the display device displays a warning area equal to or less than the limit height and equal to or larger than the warning height.

According to the exemplary embodiment, the control unit operates an alarm unit when at least one of the calculated heights from the ground is larger than the warning height.

According to the exemplary embodiment, the alarm unit outputs at least one of a warning image and a warning voice.

According to the exemplary embodiment, the control unit calculates the maximum heights of the boom, the arm, and the bucket from the ground by reflecting actual structures of the boom, the arm, and the bucket.

According to the exemplary embodiment, in calculating the maximum height of the boom from the ground, the control unit calculates the maximum height in a boom cylinder pin bracket.

According to the exemplary embodiment, in calculating the maximum height of the arm from the ground, the control unit calculates the maximum height in an arm cylinder pin bracket.

According to the exemplary embodiment, the maximum height in the arm cylinder pin bracket is calculated as the larger one between a maximum height adjacent to a first arm cylinder pin and a maximum height adjacent to a second arm cylinder pin.

In order to achieve the foregoing object, a control method of an excavator according to the present disclosure includes: activating a height limit alarm unit of an excavator; thereafter, setting a limit height and a warning height; thereafter, detecting, by a control unit, a height of each of a boom, an arm, and a bucket; thereafter, determining, by the control unit, whether the height of the boom, the arm, or the bucket is located in a warning area; and when it is determined that the height of the boom, the arm, or the bucket is located in the warning area, outputting, by the control unit, a first warning signal to the display.

According to an exemplary embodiment, the control method of the excavator according to the present disclosure further includes after outputting, by the control unit, the first warning signal to the display, determining, by the control unit, whether the height of the boom, the arm, or the bucket is close to the limit height.

According to the exemplary embodiment, when it is determined that the height of the boom, the arm, or the bucket is close to the limit height, the control unit outputs a second warning signal to the display. A warning image or a warning voice according to the second warning signal is different from a warning image or a warning voice according to the first warning signal.

According to the exemplary embodiment, in the detecting of the height of each of the boom, the arm, and the bucket, the control unit detects a maximum height in a boom cylinder pin bracket of the excavator, a maximum height in an arm cylinder pin bracket, a maximum height in a bucket link, and heights of a bucket bag and a bucket tip.

The excavator and the control method therefor according to the present disclosure may generate an alarm based on heights of a boom, an arm, and a bucket.

### BRIEF DESCRIPTION OF THE DRAWINGS

FIG. 1 is a diagram illustrating an excavator according to an exemplary embodiment of the present disclosure.

FIG. 2 is a configuration diagram schematically illustrating the excavator of FIG. 1.

FIG. 3 is a diagram for describing a method of measuring a maximum height in a boom cylinder pin bracket of FIG. 1.

FIG. 4 is a diagram for describing a method of measuring the maximum height of the arm cylinder pin bracket of FIG. 1, in which the maximum height in the arm cylinder pin bracket represents the height at the highest point adjacent to a first arm cylinder pin.

FIG. 5 is a diagram for describing a method of measuring the maximum height of the arm cylinder pin bracket of FIG. 1, in which the maximum height in the arm cylinder pin bracket represents the height at the highest point adjacent to the second arm cylinder pin.

FIG. 6 is a diagram for describing a method of measuring the maximum height in the bucket link of FIG. 1.

FIG. 7 is a diagram for describing a method of measuring the height of a bucket bag of FIG. 1.

FIG. 8 is a diagram for describing a method of measuring the height of a bucket tip of FIG. 1.

FIGS. 9 to 11 are diagrams for describing the operation of the excavator of FIG. 1.

FIG. 12 is a diagram for describing an operation method of the excavator of the present disclosure.

### DETAILED DESCRIPTION

The advantages and characteristics of the present disclosure, and a method for achieving the advantages and characteristics will become clear by referring to the exemplary embodiment, which is described below in detail, together with the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims. Accordingly, in several exemplary embodiments, well-known process steps, well-known element structures, and well-known technologies are not described in detail in order to avoid obscuring the present disclosure. Throughout the specification, the same reference numeral indicates the same constituent element.

In the present specification, when a part is said to be connected to another part, it includes not only a case in which the part is directly connected, but also a case in which the part is electrically connected with another element interposed therebetween. In addition, unless explicitly described to the contrary, the word “comprise” and variations such as “comprises” or “comprising” will be understood to imply the inclusion of stated elements but not the exclusion of any other elements.

In the present specification, terms, such as a first, a second, and a third, may be used for describing various constituent elements, but the constituent elements are not limited by the terms. The terms are used for discriminating one constituent element from other constituent elements. For example, without departing from the scope of the present disclosure, a first constituent element may be named as a second or third constituent element, and similarly, a second constituent element and a third constituent element may be alternately named.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

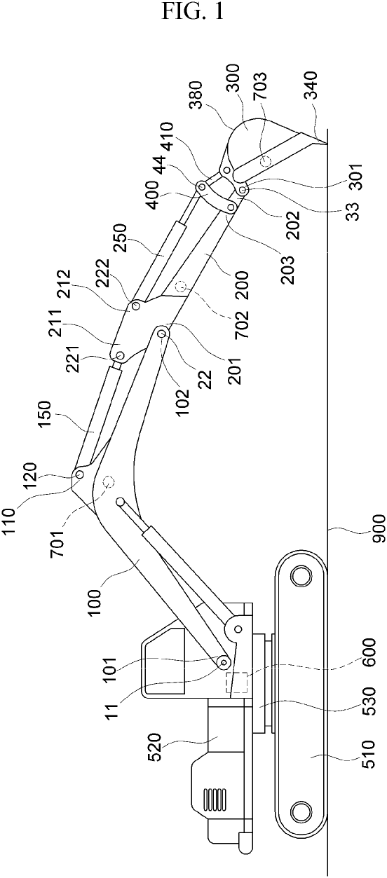

Hereinafter, an excavator and a control method therefor according to the present disclosure will be described in detail with reference to FIGS. 1 to 11.

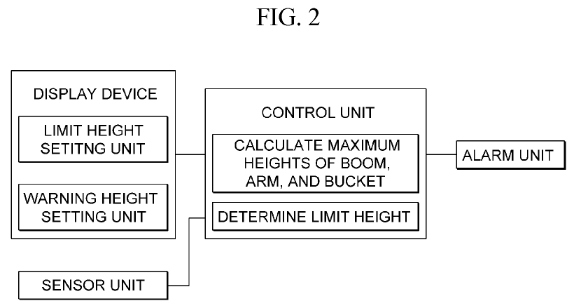

FIG. 1 is a diagram illustrating an excavator according to an exemplary embodiment of the present disclosure, and FIG. 2 is a configuration diagram schematically illustrating the excavator of FIG. 1.

Referring to FIGS. 1 to 2, an excavator according to an exemplary embodiment of the present disclosure may include a swing body 520, a traveling body 510, a vehicle connection part 530, a boom 100, an arm 200, a bucket 300, a boom cylinder 150, an arm cylinder 250, a boom cylinder pin 120, a first arm cylinder pin 221, a second arm cylinder pin 222, a bucket link 400, a first joint pin 11, a second joint pin 22, a third joint pin 33, a bucket pin 44, a display device, a sensor unit, an alarm unit, and a control unit 600. Here, the bucket 300 may include a plurality of bucket tips 340. The display device may include a limit height setting unit and a warning height setting unit. The sensor unit may include a first angle sensor 701, a second angle sensor 702, and a third angle sensor 703.

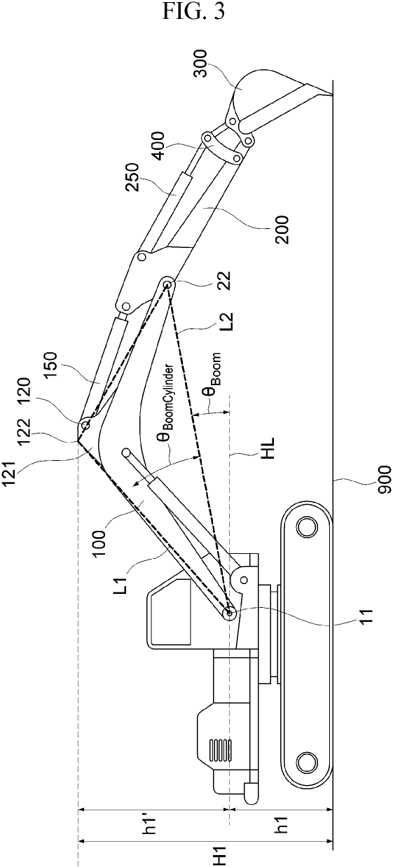

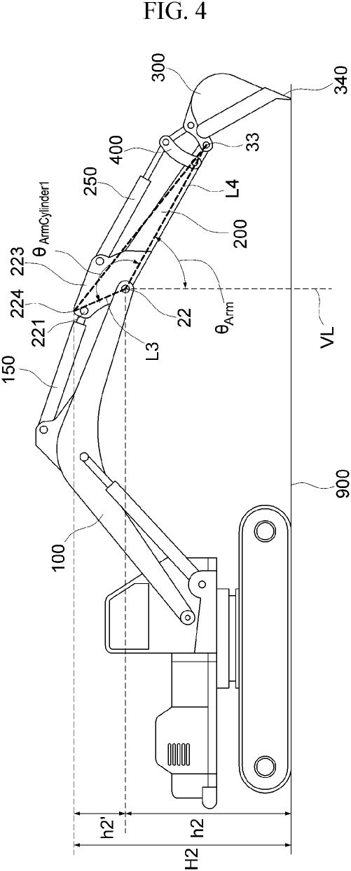

In addition, the excavator according to the exemplary embodiment of the present disclosure may include a boom cylinder pin bracket 121 (see FIG. 3) and an arm cylinder pin bracket 223 (see FIG. 4).

The vehicle connection part 530 connects the traveling body 510 and the swing body 520. The swing body 520 is rotatably connected to the vehicle connection part 530. For example, the swing body 520 may rotate 360 degrees around the vehicle connection part 530.

The first joint 101 of the boom 100 is rotatably connected to the swing body 520. The second joint 102 of the boom 100 is rotatably connected to the first joint 201 of the arm 200. The first joint 101 of the boom 100 may be disposed at one end of the boom 100, and the second joint 102 of the boom 100 may be disposed at the other end of the boom 100.

The swing body 520 and the first joint 101 of the boom 100 may be connected in a hinge manner by a first joint pin 11, and the second joint 102 of the boom 100 and the first joint 201 of the arm 200 may be connected in a hinge manner by a second joint pin 22.

The boom cylinder pin bracket 121 may be disposed between one end of the boom 100 and the other end of the boom 100. The cylinder connection part 110 and the boom cylinder pin 120 of the boom 100 may be disposed on the boom cylinder pin bracket 121.

The first joint 201 of the arm 200 is rotatably connected to the second joint 102 of the boom 100. The second joint 202 of the arm 200 is connected to the joint 301 of the bucket 300. The first joint 201 of the arm 200 may be disposed at one end of the arm 200, and the second joint 202 of the arm 200 may be disposed at the other end of the arm 200.

The arm cylinder pin bracket 223 may be disposed between one end of the arm 200 and the other end of the arm 200. The first joint 201 of the arm 200 may be disposed on the arm cylinder pin bracket 223. The arm cylinder pin bracket 223 may constitute one end of the arm 200. In addition, in the arm cylinder pin bracket 223, a first cylinder connection part 211 of the arm, a second cylinder connection part 212 of the arm, the first arm cylinder pin 221, and the second arm cylinder pin 222 may be disposed.

The second joint 202 of the arm 200 and the joint 301 of the bucket 300 may be connected in a hinge manner by a third joint pin 33.

The joint 301 of the bucket 300 is rotatably connected to the second joint 202 of the arm 200. The joint 301 of the bucket 300 may be disposed at one end of the bucket 300. On the other hand, a plurality of bucket tips 340 may be disposed at the other end of the bucket 300.

One end of the boom cylinder 150 is connected to the cylinder connection part 110 of the boom 100. In this case, one end of the boom cylinder 150 is connected to the cylinder connection part 110 of the boom 100 through the boom cylinder pin 120. One end of the boom cylinder 150 is rotatably connected to the cylinder connection part 110 of the boom 100.

The other end of the boom cylinder 150 is connected to the first cylinder connection part 211 of the arm 200. Here, the other end of the boom cylinder 150 is connected to the first cylinder connection part 211 of the arm 200 through the first arm cylinder pin 221. The other end of the boom cylinder 150 is rotatably connected to the first cylinder connection part 211 of the arm 200.

One end of the arm cylinder 250 is connected to the second cylinder connection part 212 of the arm 200. Here, one end of the arm cylinder 250 is connected to the second cylinder connection part 212 of the arm 200 through the second arm cylinder pin 222. One end of the arm cylinder 250 is rotatably connected to the second cylinder connection part 212 of the arm 200.

The other end of the arm cylinder 250 is connected to the bucket link 400. Here, the other end of the arm cylinder 250 is connected to the bucket link 400 and the cylinder connection part 410 of the bucket 300 through the bucket pin 44. The other end of the arm cylinder 250 is rotatably connected to the bucket link 400 and the cylinder connection part 410 of the bucket 300.

One end of the bucket link 400 is rotatably connected to the third joint 203 of the arm 200, and the other end of the bucket link 400 is rotatably connected to the other end of the arm cylinder 250 and the cylinder connection part 410 of the bucket 300.

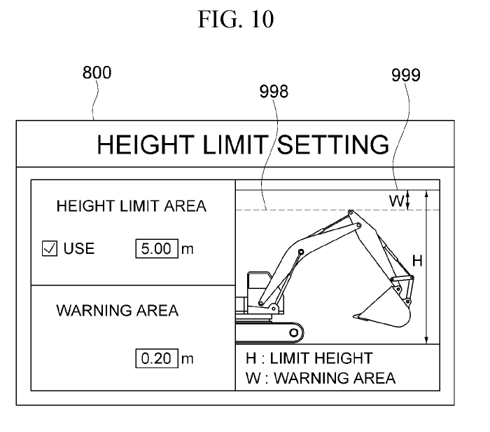

The display device is disposed in the excavator, and may display the shapes of the boom 100, the arm 200, and the bucket 300 of the excavator and the terrain where the excavator is located. The shapes of the boom 100, the arm 200, and the bucket 300 of the excavator and the terrain where the excavator is located may be displayed through a separate display window provided in the display device. Alternatively, as a screen of a display 800 illustrated in FIG. 10 is switched, a separate display window may appear to display the screens.

The display device may be provided with a limit height setting unit.

In the limit height setting unit of the display device, a height required for work in the terrain where the excavator is located may be set. The user may input (set) the height required for work in the terrain where the excavator is located in the limit height setting unit provided in the display device.

The limit height setting unit provided in the display device may be displayed through a separate display window, and the user may input (set) the limit height to the limit height setting unit displayed on the display window. Alternatively, the setting of the limit height may be done by inputting (setting) the limit height in the height limit area of the screen of the display 800 illustrated in FIG. 10.

In addition, the display device may be provided with a warning height setting unit.

In the warning height setting unit of the display device, a warning height lower than the limit height input (set) to the limit height setting unit may be set.

The user may input (set) a warning height lower than the limit height in the warning height setting unit provided in the display device. Alternatively, the warning height may be determined by the user’s work tendency or the reaction speed of the excavator. Information on the user’s work tendency and/or the reaction speed of the excavator may be stored in the control unit, and the control unit may determine the warning height using the stored user’s work tendency and/or reaction speed of the excavator. In this case, the control unit may set the warning height to be lower than the limit height.

The limit height input (set) in the limit height setting unit and the warning height input (set) in the warning height setting unit may be transmitted to the control unit by an electrical signal.

The warning height setting unit provided in the display device may be displayed through a separate display window, and the user may input (set) the warning height to the warning height setting unit displayed on the display window. Alternatively, the input (setting) of the warning height may be done by inputting (setting) the warning height in a warning area of the screen of the display 800 illustrated in FIG. 10.

Alternatively, the display device may display the warning height input (set) by the user or determined by the control unit to be distinguished from the limit height to the user. In this case, the display device may divide (separate) the display window indicating the warning height and the display window indicating the limit height and display the display windows to the user.

The display device may display the limit height and the warning height along with the terrain where the excavator is located. Specifically, the display device may display the limit height input (set) by the user to the limit height setting unit together with the terrain where the excavator is located. In addition, the display device may display the warning height input (set) to the warning height setting unit by the user or determined by the control unit together with the terrain where the excavator is located.

The display device may display a warning area equal to or larger than the warning height and equal to or less than the limit height. For example, the display device may display a warning area like the warning area W of the screen of the display 800 illustrated in FIG. 10. The color of the warning area may be displayed differently from the background color, or the warning area may be displayed in a blinking manner.

The first angle sensor 701 of the sensor unit may be disposed on the boom 100. The first angle sensor 701 detects the angle of the boom 100. The angle of the boom 100 may be transmitted to the control unit by an electrical signal.

The second angle sensor 702 of the sensor unit may be disposed on the arm 200. The second angle sensor 702 detects the angle of the arm 200. The angle of the arm 200 may be transmitted to the control unit by an electrical signal.

The third angle sensor 703 of the sensor unit may be disposed in the bucket 300. The third angle sensor 703 detects the angle of the bucket 300. The angle of the bucket 300 may be transmitted to the control unit by an electrical signal.

The alarm unit may output at least one of a warning image and a warning voice. Specifically, the alarm unit may output a warning image and/or a warning voice according to an electrical signal of the control unit. Here, the warning voice includes a warning voice, such as a machine voice.

The control unit 600 may calculate the maximum heights of the boom 100, the arm 200, and the bucket 300 from the ground 900, respectively.

Specifically, in calculating the maximum height of the boom 100 from the ground 900, the control unit 600 may calculate a maximum height 122 in the boom cylinder pin bracket 121. That is, the maximum height of the boom 100 from the ground 900 represents the highest point 122 in the boom cylinder pin bracket 121 to the highest point 122.

Also, in calculating the maximum height of the arm 200 from the ground 900, the control unit 600 may calculate maximum heights 224 and 225 in the arm cylinder pin bracket 223. That is, the maximum height of the arm 200 from the ground 900 represents the highest points 224 and 225 in the arm cylinder pin bracket 223. Here, the maximum height in the arm cylinder pin bracket 223 may be calculated (determined) as the larger one between the maximum height 224 adjacent to the first arm cylinder pin 221 and the maximum height 225 adjacent to the second arm cylinder pin 222.

In addition, the control unit 600 may calculate the maximum height from the ground 900 of each of the bucket link 400 on which the bucket pin 44 is disposed, the bucket bag 380, and the bucket tip 340 .

In addition, in calculating the maximum height of each of the boom 100, the arm 200, and the bucket 300 from the ground, the control unit 600 may calculate the maximum height of each of the boom 100, the arm 200, and the bucket 300 from the ground by reflecting the actual structure (or actual shape) of the boom 100, the arm 200, and the bucket 300. The display device may display the shapes of the boom 100, the arm 200, and the bucket 300 of the excavator and the terrain where the excavator is located, and the control unit may reflect the shapes of the boom 100, the arm 200, and the bucket 300 of the excavator for calculating the maximum height of each of the boom 100, the arm 200, and the bucket 300 from the ground.

In addition, when at least one of the above calculated heights from the ground (the maximum heights of the boom 100, the arm 200, and the bucket 300 from the ground) is larger than the warning height, the control unit may operate the alarm unit.

FIG. 3 is a diagram for describing a method of measuring the maximum height in the boom cylinder pin bracket 121 of FIG. 1.

In calculating the maximum height H1 from the ground 900 of the boom 100, the maximum height H1 of the boom cylinder pin bracket 121 may be calculated by the above-described control unit 600.

The maximum height H1 of the boom cylinder pin bracket 121 means the height H1 from the ground 900 to the highest point 122 in the boom cylinder pin bracket 121 in the vertical direction. The maximum height H1 of the boom cylinder pin bracket 121 may be calculated by Equation 1 below.

$${\text{Y}}_{\text{BoomCylinderPinBra}} = {\text{Y}}_{\text{JointPin1}} + {\text{L}}_{\text{Boom}} * sin \left({θ}_{\text{Boom}} + {θ}_{\text{BoomCylinder}}\right)$$

In Equation 1 above, Y_{BoomCylinderPinBra} represents the maximum height H1 of the boom cylinder pin bracket 121, Y_{JointPin1} represents the height h1 of the first joint pin 11, L_{Boom} represents the length of a virtual first line segment L1 connecting the first joint pin 11 and the highest point 122 in the boom cylinder pin bracket 121, θ_{Boom} means an angle between a virtual horizontal line HL and a virtual second line segment L2, and θ_{BoomCylinder} means an angle between the first line segment L1 and the second line segment L2. Here, the height h1 of the first joint pin 11 means the distance from the ground 900 to the first joint pin 11 in the vertical direction, the virtual horizontal line HL means a line extending from the first joint pin 11 toward the front surface of the swing body 520 and perpendicular to the direction of gravity, and the second line segment L2 means a straight line connecting the first joint pin 11 and the second joint pin 22. Here, Y_{JointPin1}, L_{Boom}, and θ_{BoomCylinder} are fixed values. However, the Y_{JointPin1}, L_{Boom}, and θ_{BoomCylinder} may vary depending on excavator model. Meanwhile, θ_{Boom} may be detected by the above-described first angle sensor 701.

“L_{Boom} * sin(θ_{Boom}+ θ_{BoomCylinder})” in Equation 1 above means the height h1′ from the horizontal line HL to the highest point 122 in the boom cylinder pin bracket 121 in the vertical direction. Therefore, by Equation 1 above, the maximum height H1 of the boom cylinder pin bracket 121 from the ground 900 in the vertical direction may be calculated. In the case of the example illustrated in FIG. 3, “θ_{Boom} + θ_{BoomCylinder}” is smaller than 90 degrees counterclockwise with respect to the horizontal line HL, so “sin(θ_{Boom} + θ_{BoomCylinder})” has a positive value. Therefore, Equation 1 represents the size obtained by adding the value of “sin(θ_{Boom} + θ_{BoomCylinder})” to the height of the first joint pin 11.

FIG. 4 is a diagram for describing a method of measuring the maximum height of the arm cylinder pin bracket 223 of FIG. 1, in which the maximum height in the arm cylinder pin bracket 223 represents the height at the highest point 224 adjacent to a first arm cylinder pin 221.

In calculating the maximum height H2 of the arm 200 from the ground 900, the maximum height H2 of the arm cylinder pin bracket 223 may be calculated by the above-described control unit 600. The maximum height H2 at the arm cylinder pin bracket 223 represents the height (maximum height) at the highest point 224 adjacent to the first arm cylinder pin 221.

The maximum height H2 of the arm cylinder pin bracket 223 means the height H2 from the ground 900 to the highest point 224 adjacent to the first arm cylinder pin 221 in the vertical direction. The maximum height H2 of the arm cylinder pin bracket 223 may be calculated by Equation 2 below.

$${\text{Y}}_{\text{ArmCylinderPinBra1}} = {\text{Y}}_{\text{JointPin2}} - {\text{L}}_{\text{Arm1}} * cos \left({θ}_{\text{Arm}} + {θ}_{\text{ArmCylinder1}}\right)$$

In Equation 2 above, Y_{ArmCylinderPinBra1} represents the maximum height H2 of the arm cylinder pin bracket 223, and means the height H2 to the highest point 224 adjacent to the first arm cylinder pin 221. Y_{Jointpin2} represents the height h2 of the second joint pin 22, L_{Arm1} represents the length of a virtual third line segment L3 connecting the second joint pin 22 and the highest point 224 adjacent to the first arm cylinder pin 221, θ_{Arm} means an angle between a virtual vertical line VL and a virtual fourth line segment L4, and θ_{ArmCylinder1} means an angle between the fourth line segment L4 and the third line segment L3. Here, the height h2 of the second joint pin 22 means the distance from the ground 900 to the second joint pin 22 in the vertical direction, the virtual vertical line VL means a line parallel to the direction of gravity, the third line segment L3 means a straight line connecting the second joint pin 22 and the highest point 224 adjacent to the first arm cylinder pin 221, and the fourth line segment L4 means a straight line connecting the second joint pin 22 and the third joint pin 33. Here, L_{Arm1} is a fixed value. However, the L_{Arm1} may vary depending on excavator model. Meanwhile, θ_{Arm} may be detected by the above-described second angle sensor 702.

“L_{Arm1} * cos(θ_{Arm} + θ_{ArmCylinder1})” in Equation 2 above means the height h2′ from the second joint pin 22 to the highest point 224 adjacent to the first arm cylinder pin 221 in the vertical direction. Therefore, the maximum height H2 of the arm cylinder pin bracket 223 in the vertical direction from the ground 900 may be calculated by Equation 2 above. In the case of the example illustrated in FIG. 4, “(θ_{Arm} + θ_{ArmCylinder1})” is larger than 90 degrees counterclockwise based on the vertical line VL, so “cos(θ_{Arm} + θ_{ArmCylinder1})” has a negative value. Accordingly, Equation 2 represents the size obtained by adding the value of “cos(θ_{Arm} + θ_{ArmCylinder1})” to the height of the second joint pin 22.

Meanwhile, Y_{JointPin2} of Equation 2 may be defined as Equation 3 below.

$${\text{Y}}_{\text{JointPin2}} = {\text{Y}}_{\text{JointPin1}} + {\text{L}}_{\text{Boom}} * sin \left({θ}_{\text{Boom}}\right)$$

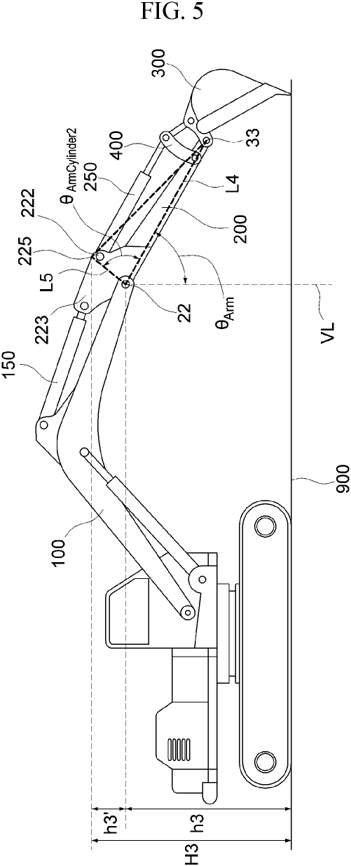

FIG. 5 is a diagram for describing a method of measuring the maximum height of the arm cylinder pin bracket 223 of FIG. 1, in which the maximum height in the arm cylinder pin bracket represents the height at the highest point 225 adjacent to the second arm cylinder pin 222.

In calculating the maximum height H2 of the arm 200 from the ground 900, the maximum height H3 of the arm cylinder pin bracket 223 may be calculated by the above-described control unit 600. The maximum height H3 at the arm cylinder pin bracket 223 represents the height (maximum height) at the highest point 225 adjacent to the second arm cylinder pin 222.

The maximum height H3 of the arm cylinder pin bracket 223 means the height H3 from the ground 900 to the highest point 225 adjacent to the second arm cylinder pin 222 in the vertical direction. The maximum height H3 of the arm cylinder pin bracket 223 may be calculated by Equation 4 below.

$${\text{Y}}_{\text{ArmCylinderPinBra2}} = {\text{Y}}_{\text{JointPin2}} - {\text{L}}_{\text{Arm2}} * cos \left({θ}_{\text{Arm}} + {θ}_{\text{ArmCylinder2}}\right)$$

In Equation 4 above, Y_{AnnCylinderPinBra2} represents the maximum height H3 of the arm cylinder pin bracket 223, and means the height H3 to the highest point 225 adjacent to the second arm cylinder pin 222. Y_{JointPin2} represents the height h3 of the second joint pin 22, L_{Arm2} represents the length of a virtual fifth line segment L5 connecting the second joint pin 22 and the highest point 225 adjacent to the second arm cylinder pin 222, θ_{Arm} means the angle between the virtual vertical line VL and the virtual fourth line segment L4, and θ_{ArmCylinder2} means an angle between the fourth line segment L4 and the fifth line segment L5. Here, the height h3 of the second joint pin 22 means the distance from the ground 900 to the second joint pin 22 in the vertical direction, the virtual vertical line VL means a line parallel to the direction of gravity, the fifth line segment L5 means a straight line connecting the second joint pin 22 and the highest point 225 adjacent to the second arm cylinder pin 222, and the fourth line segment L4 means a straight line connecting the second joint pin 22 and the third joint pin 33. Here, L_{Arm2} is a fixed value. However, the L_{Arm2} may vary depending on excavator model. Meanwhile, θ_{Arm} may be detected by the above-described second angle sensor 702.

“L_{Arm2} * cos(θ_{Arm} + θ_{ArmCylinder2})” in Equation 4 above means the height h3′ from the second joint pin 22 to the highest point 225 adjacent to the second arm cylinder pin 222 in the vertical direction. Therefore, by Equation 4 above, the maximum height H3 of the arm cylinder pin bracket 223 from the ground 900 in the vertical direction may be calculated. In the case of the example illustrated in FIG. 5, “(θ_{Arm} + θ_{ArmCylinder2})” is larger than 90 degrees counterclockwise based on the vertical line VL, so “cos(θ_{Arm} + θ_{ArmCylinder2})” has a negative value. Accordingly, Equation 4 represents the size obtained by adding the value of “cos(θ_{Arm} + θ_{ArmCylinder2})” to the height of the second joint pin 22.

Meanwhile, Y_{JointPin2} of Equation 2 may be defined as Equation 3 below.

The above-described maximum height in the arm cylinder pin bracket 223 may be calculated as the larger one between the maximum height 224 adjacent to the first arm cylinder pin 221 and the maximum height 225 adjacent to the second arm cylinder pin 222.

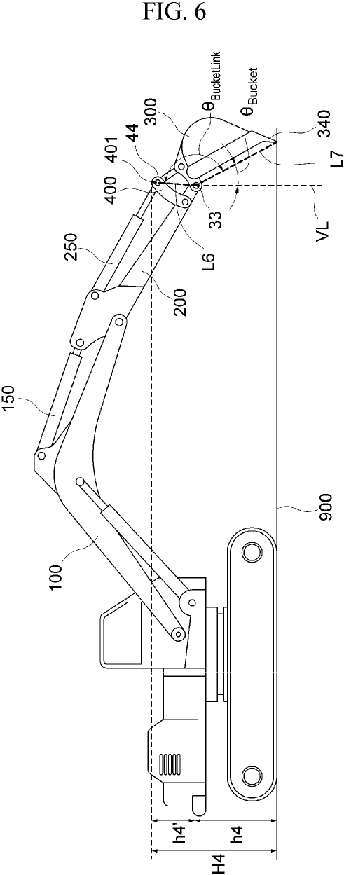

FIG. 6 is a diagram for describing a method of measuring the maximum height in the bucket link 400 of FIG. 1.

In calculating the maximum height H4 of the bucket link 400 from the ground 900, the maximum height H4 of the bucket link 400 may be calculated by the above-described control unit 600.

The maximum height H4 of the bucket link 400 means the height H4 from the ground 900 to the highest point 401 in the bucket link 400 in the vertical direction. The maximum height H4 of the bucket link 400 may be calculated by Equation 5 below.

$${\text{Y}}_{\text{BucketLink}} = {\text{Y}}_{\text{JointPin3}} - {\text{L}}_{\text{BucketLink}} * cos \left({θ}_{\text{Bucket}} + {θ}_{\text{Bucketlink}}\right)$$

In Equation 5 above, Y_{BucketLink} represents the maximum height H4 of the bucket link 400, Y_{JointPin3} represents the height h4 of the third joint pin 33, L_{BucketLink} represents the length of a virtual sixth line segment L6 connecting the third joint pin 33 and the highest point 401 in the bucket link 400, θ_{Bucket} means an angle between the virtual vertical line VL and a virtual seventh line segment L7, and θ_{Bucketlink} means an angle between the sixth line segment L6 and the seventh line segment L7. Here, the height h4 of the third joint pin 33 means the distance from the ground 900 to the third joint pin 33 in the vertical direction, the virtual vertical line VL means a line parallel to the direction of gravity, the sixth line segment L6 is a straight line connecting the third joint pin 33 and the highest point 401 in the bucket link 400, and the seventh line segment L7 means a straight line connecting the third joint pin 33 and the bucket tip 340. Here, L_{BucketLink} is a fixed value. However, the L_{BucketLink} may vary depending on excavator model. Meanwhile, θ_{Bucket} may be detected by the third angle sensor 703 described above.

“L_{BucketLink} * cos(θ_{Bucket} + θ_{Bucketlink})” in Equation 5 above means the distance h4′ from the third joint pin 33 to the highest point 401 in the bucket link 400 in the vertical direction. Therefore, by Equation 5 above, the maximum height H4 of the bucket link 400 from the ground 900 in the vertical direction may be calculated. In the case of the example illustrated in FIG. 6, “(θ_{Bucket} + θ_{Bucketlink})” is larger than 90 degrees counterclockwise from the vertical line VL, so “cos(θ_{Bucket} + θ_{Bucketlink})” has a negative value. Therefore, Equation 5 represents the size obtained by adding the value of “cos(θ_{Bucket} + θ_{Bucketlink})” to the height of the third joint pin 33.

Meanwhile, Y_{JointPin3} of Equation 5 may be defined as Equation 6 below.

$${\text{Y}}_{\text{JointPin3}} = {\text{Y}}_{\text{JointPin2}} - {\text{L}}_{\text{Arm}} * cos \left({θ}_{\text{Arm}}\right)$$

L_{Arm} in Equation 6 means the length of the aforementioned fourth line segment L4. Here, L_{Arm} is a fixed value. However, the L_{Arm} may vary depending on excavator model.

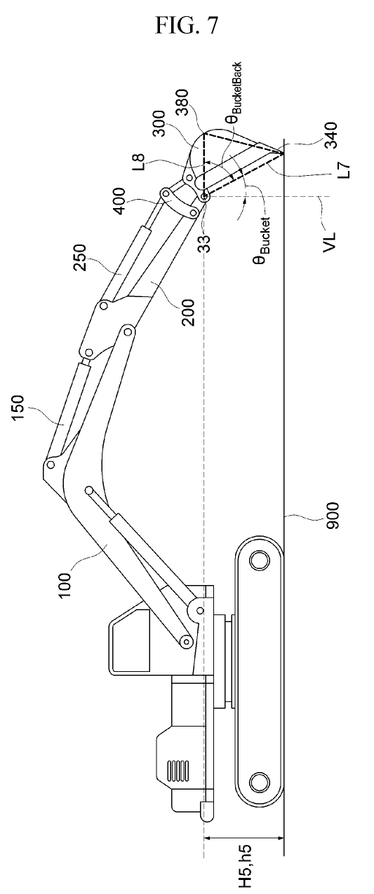

FIG. 7 is a diagram for describing a method of measuring the height of the bucket bag 380 of FIG. 1.

The height H5 of the bucket bag 380 may be calculated by the control unit 600 described above.

The height H5 of the bucket bag 380 means the height from the ground 900 to the bucket bag 380 in the vertical direction. The height H5 of the bucket bag 380 may be calculated by Equation 7 below.

$${\text{Y}}_{\text{BucketBack}} = {\text{Y}}_{\text{JointPin3}} - {\text{L}}_{\text{BucketBack}} * \text{cos} \left({θ}_{\text{Bucket}} + {θ}_{\text{BucketBack}}\right)$$

In Equation 7 above, Y_{BucketBack} represents the height H5 of the bucket bag 380, Y_{JointPin3} represents the height h5 of the third joint pin 33, L_{BucketBack} represents a length of a virtual eighth line segment L8 connecting the third joint pin 33 and the bucket bag 380, θ_{Bucket} means an angle between the virtual vertical line VL and the virtual seventh line segment L7, and θ_{BucketBack} means an angle between the seventh line segment L7 and the eighth line segment L8. Here, the height h5 of the third joint pin 33 means the distance from the ground 900 to the third joint pin 33 in the vertical direction, the virtual vertical line VL means a line parallel to the direction of gravity, the eighth line segment L8 means a straight line connecting the third joint pin 33 and the bucket bag 380, and the seventh line segment L7 means a straight line connecting the third joint pin 33 and the bucket tip 340. Here, L_{BucketBack} is a fixed value. However, the L_{BucketBack} may vary depending on excavator model.

“L_{BucketBack} * cos(θ_{Bucket} + θ_{BucketBack})” in Equation 7 above means the height from the third joint pin 33 to the bucket bag 380 in the vertical direction. Accordingly, the height H5 from the ground 900 to the bucket bag 380 in the vertical direction may be calculated by Equation 7 above. In the case of the example illustrated in FIG. 7, “(θ_{Bucket} + θ_{BucketBack})” is 90 degrees counterclockwise with respect to the vertical line VL, so “cos(θ_{Bucket} + θ_{BucketBack})” has a value of zero. Therefore, Equation 7 represents the size obtained by adding the value of “cos(θ_{Bucket} + θ_{BucketBack})” to the height of the third joint pin 33.

Meanwhile, Y_{JointPin3} of Equation 7 may be defined as Equation 6 below.

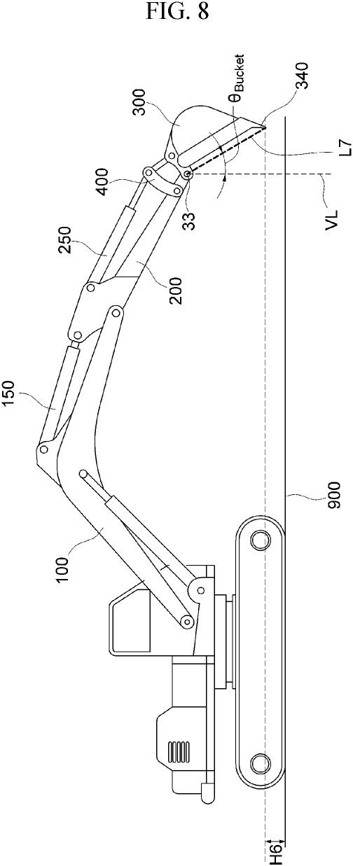

FIG. 8 is a diagram for describing a method of measuring the height of the bucket tip 340 of FIG. 1.

The height H5 of the bucket tip 340 may be calculated by the control unit 600 described above.

The height H5 of the bucket tip 340 means the height from the ground 900 to the bucket tip 340 in the vertical direction. The height H6 of the bucket tip 340 may be calculated by Equation 8 below.

$${\text{Y}}_{\text{BucketTip}} = {\text{Y}}_{\text{JointPin3}} - {\text{L}}_{\text{Bucket}} * cos \left({θ}_{\text{Bucket}}\right)$$

In Equation 8 above, Y_{BucketTip} represents the height H5 of the bucket tip 340, Y_{JointPin3} represents the height h5 of the third joint pin 33, L_{Bucket} represents the length of the line segment (that is, the seventh line segment L7) connecting the third joint pin 33 and the bucket tip 340, and θ_{Bucket} represents an angle between the virtual vertical line VL and the seventh line segment L7.

“L_{Bucket} * cos(θ_{Bucket})” in Equation 8 above means the height from the third joint pin 33 to the bucket tip 340 in the vertical direction. Accordingly, the height H6 from the ground 900 to the bucket tip 340 in the vertical direction may be calculated by Equation 8 above. In the case of the example illustrated in FIG. 8, “θ_{Bucket}” is smaller than 90 degrees counterclockwise based on the vertical line VL, so “cos(θ_{Bucket})” has a positive value. Therefore, Equation 8 represents the size obtained by subtracting the value of “L_{Bucket} * cos(θ_{Bucket})” from the height of the third joint pin 33.

Meanwhile, Y_{JointPin3} of Equation 8 may be defined as Equation 6 above.

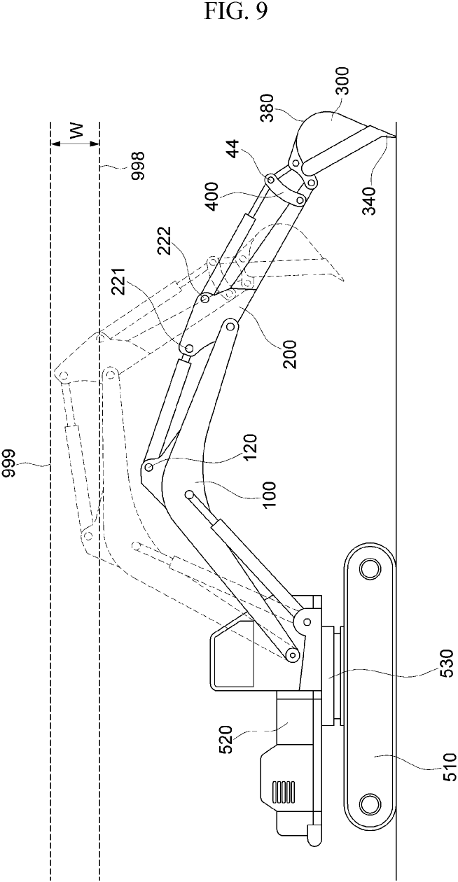

FIGS. 9 to 11 are diagrams for describing the operation of the excavator of FIG. 1.

As illustrated in FIGS. 9 and 10, the excavator operator may input a limit height 999 required to work in the excavator and the terrain where the excavator is located. The input of the limit height 999 is possible through the limit height setting unit of the display device. The limit height 999 may be set by various structures disposed in the working space of the excavator. For example, when the excavator works indoors, such as a warehouse, the limit height 999 may be the height from the ground 900 to the roof of the warehouse. As another example, when an electric wire or communication line of an electric pole is located on the upper part of the excavator working outdoors, the limit height 999 may be the height from the ground 900 to the electric wire or communication line.

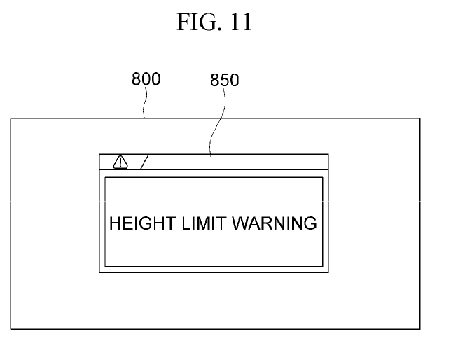

The operator may input the above-mentioned limit height 999 to the display 800 disposed on the display device of the excavator. The excavator that received the limit height 999 detects heights from the boom 100, the arm 200, and the buck 300 from the ground 900 in real time, and when any one of the detected heights is close to the limit height 999, the excavator may display a warning image as illustrated in FIG. 11 on the display 800. For example, as illustrated in FIG. 10, when any one of the maximum height in the boom 100 including the boom cylinder pin bracket 121, the maximum height in the arm 200 including the arm cylinder pin bracket 223, the maximum height in the bucket link 400, and the heights of the arm 200, the bucket bag 380, and the bucket tip 340 is located in a warning area W, the control unit 600 may control the display 800 to display a warning image as illustrated in FIG. 11. Meanwhile, the display 800 may further output a warning voice in addition to the warning image. The warning image may be output to the display 800 in the form of a pop-up window.

The warning area W described above may be set by, for example, a limit height 999 and a warning height 998. The warning height 998 is lower than the limit height 999. The warning area W may include an area between the warning height 998 and the limit height 999. The lower limit of the warning area W may be equal to the warning height 998, and the upper limit of the warning area W may be equal to the limit height 999. The size of the warning area W is a value obtained by subtracting the warning height 998 from the limit height 999.

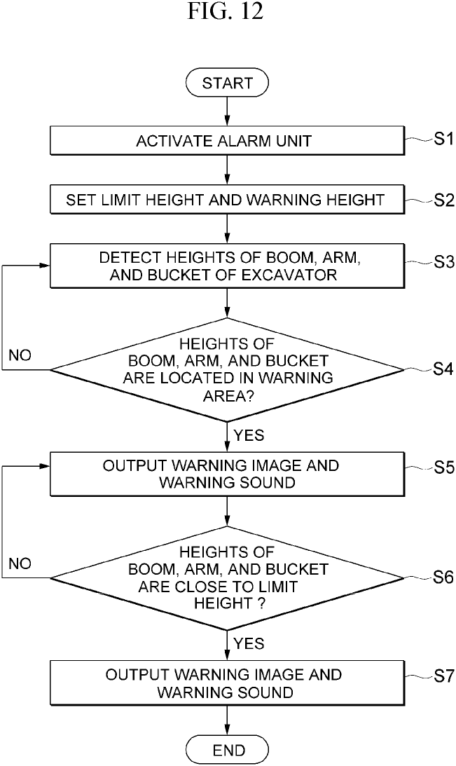

FIG. 12 is a diagram for describing an operation method of the excavator of the present disclosure.

First, the height limit alarm unit of the excavator is activated (S1). When the height limit alarm unit is activated, the alarm unit has a state capable of outputting any one of a warning image and a warning voice. The alarm unit may be included in the display 800. Otherwise, the display 800 may serve as the alarm unit.

Then, the limit height 998 and the warning height 999 are set (S2). For example, the operator may input the desired limit height 999 and warning height 998 to the display. The warning height is less than the limit height. The warning area W is set by the limit height 999 and the warning height 998.

Subsequently, the control unit 600 detects a height of each of the boom 100, the arm 200, and the bucket 300 (S3). For example, the control unit 600 detects the maximum height in the boom cylinder pin bracket 121 of the excavator, the maximum height in the arm cylinder pin bracket 223, the maximum height in the bucket link 400, and the heights of the bucket bag 380 and the bucket tip 340 (S3). The control unit 600 of the excavator according to the exemplary embodiment of the present disclosure may calculate the maximum heights of each of the boom 100, the arm 200, and the bucket 300 from the ground by reflecting the actual structures (or actual shapes) of the boom 100, the arm 200, and the bucket 300. The display device may display the shapes of the boom 100, the arm 200, and the bucket 300 of the excavator and the terrain where the excavator is located, and the control unit may reflect the shapes of the boom 100, the arm 200, and the bucket 300 of the excavator in calculating the maximum height of each of the boom 100, the arm 200, and the bucket 300 from the ground.

Thereafter, the control unit 600 determines whether the height of the boom 100, the arm 200 and/or the bucket 300 is located in the warning area W (S4). For example, the control unit 600 determines whether any one of the maximum height in the boom cylinder pin bracket 121 of the excavator, the maximum height in the arm cylinder pin bracket 223, the maximum height in the bucket link 400, and the heights of the bucket bag 380 and the bucket tip 340 invades the warning area W (S4). In this case, the lower limit of the warning area W may or may not be included in the warning area W.

When it is determined that the height of any one of the boom 100, the arm 200 and the bucket 300 is located in the warning area W, for example, when it is determined that any one of the maximum height at the boom cylinder pin bracket 121, the maximum height at the arm cylinder pin bracket 223, the maximum height at the bucket link 400, and the heights of the bucket bag 380 and the bucket tip 340 is located in the warning area W, the control unit 600 outputs a warning signal (a first warning signal) to the display 800. The display 800 outputs at least one of a warning image and a warning voice according to the warning signal (the first warning signal) (S5).

On the other hand, when it is determined that the heights of the boom 100, the arm 200, and the bucket 300 are not located in the warning area (W), for example, when it is determined that all of the maximum height at the boom cylinder pin bracket 121, the maximum height at the arm cylinder pin bracket 223, the maximum height at the bucket link 400, and the heights of the bucket bag 380 and the bucket tip 340 are not located in the warning area W, the control unit 600 detects the maximum height in the boom cylinder pin bracket 121, the maximum height in the arm cylinder pin bracket 223, the maximum height in the bucket link 400, and the heights of the bucket bag 380 and the bucket tip 340 again (S3).

Further, even when the display 800 outputs at least one of the warning image and the warning voice according to the warning signal (the first warning signal) (S5), the control unit 600 determines whether the height of the boom 100, the arm 200, and/or the bucket 300 is close to the limit height 999 (S6). For example, the control unit 600 determines whether at least one of the maximum height in the boom cylinder pin bracket 121, the maximum height in the arm cylinder pin bracket 223, the maximum height in the bucket link 400, and the heights of the bucket bag 380 and the bucket tip 340 is close to the limit height 999 (S6).

When it is determined that the height of any one of the boom 100, the arm 200 and the bucket 300 is close to the limit height 999, for example, it is determined that at least one of the maximum height in the boom cylinder pin bracket 121, the maximum height in the arm cylinder pin bracket 223, the maximum height in the bucket link 400, and the heights of the bucket bag 380 and the bucket tip 340 is close to the limit height 999, the control unit 600 outputs a warning signal (a second warning signal) to the display 800. The display 800 outputs at least one of a warning image and a warning voice according to the warning signal (second warning signal) (S7).

The warning image and/or the warning voice S7 according to the second warning signal are distinguished (different) from the warning image and/or the warning voice S5 according to the first warning signal that the display 800 is currently outputting.

In order to output the warning image and/or warning voice S7 according to the separate second warning signal, which is distinguished from the warning image and/or the warning voice S5 according to the first warning signal currently output on the display 800, the distance based on which the control unit 600 determines whether at least one of the maximum height in the boom cylinder pin bracket 121, the maximum height in the arm cylinder pin bracket 223, the maximum heights in the bucket link 400 and the heights of the bucket bag 380 and the bucket tip 340 is close to the limit height 999 may be set by a user.

On the other hand, when it is determined that the height of the boom 100, the arm 200, and the bucket 300 are not close to the limit height 999, for example, when it is determined that the maximum height at the boom cylinder pin bracket 121, the maximum height at the arm cylinder pin bracket 223, the maximum height at the bucket link 400, and the heights of the bucket bag 380 and the bucket tip 340 are not close to the limit height 999, the display 800 continues to output at least one of the currently output warning image and warning voice according to the warning signal (S5).

The present disclosure described above is not limited to the foregoing exemplary embodiment and the accompanying drawings, and it will be apparent to those skilled in the art that various substitutions, modifications, and changes can be made without departing from the technical spirit of the present disclosure.

[Description of Reference Numeral]

| | |
|---|---|
| 100: Boom | 200: Arm |
| 300: Bucket | 120: Boom cylinder pin |
| 150: Boom cylinder | 250: Arm cylinder |
| 400: Bucket link | 900: Ground |
| 11: First joint pin | 22: Second joint pin |
| L1: First segment line | L2: Second segment line |
| HL: Horizontal line | |

1. An excavator, comprising:
a display device for displaying shapes of a boom, an arm, and a bucket of an excavator and a terrain where the excavator is located;
a control unit for calculating maximum heights of the boom, the arm, and the bucket from the ground;
a limit height setting unit which is provided in the display device and in which a limit height required for work in the terrain where the excavator is located is set by a user; and
a warning height setting unit which is provided in the display device and in which a warning height lower than the limit height is set,
wherein the display device displays the limit height and the warning height together with the terrain where the excavator is located.

2. The excavator of claim 1, wherein the warning height is determined by user’s work tendency or a reaction speed of the excavator.

3. The excavator of claim 1, wherein the display device displays the warning height to the user so as to be distinguished from the limit height.

4. The excavator of claim 1, wherein the display device displays a warning area equal to or less than the limit height and equal to or larger than the warning height.

5. The excavator of claim 1, wherein the control unit operates an alarm unit when at least one of the calculated heights from the ground is larger than the warning height.

6. The excavator of claim 5, wherein the alarm unit outputs at least one of a warning image and a warning voice.

7. The excavator of claim 1, wherein the control unit calculates the maximum heights of the boom, the arm, and the bucket from the ground by reflecting actual structures of the boom, the arm, and the bucket.

8. The excavator of claim 1, wherein in calculating the maximum height of the boom from the ground, the control unit calculates the maximum height in a boom cylinder pin bracket.

9. The excavator of claim 1, wherein in calculating the maximum height of the arm from the ground, the control unit calculates the maximum height in an arm cylinder pin bracket.

10. The excavator of claim 9, wherein the maximum height in the arm cylinder pin bracket is calculated as the larger one between a maximum height adjacent to a first arm cylinder pin and a maximum height adjacent to a second arm cylinder pin.

11. A control method of an excavator, the control method comprising:
activating a height limit alarm unit of an excavator;
thereafter, setting a limit height and a warning height;
thereafter, detecting, by a control unit, a height of each of a boom, an arm, and a bucket;
thereafter, determining, by the control unit, whether the height of the boom, the arm, or the bucket is located in a warning area; and
when it is determined that the height of the boom, the arm, or the bucket is located in the warning area, outputting, by the control unit, a first warning signal to the display.

12. The control method of claim 11, further comprising:
after outputting, by the control unit, the first warning signal to the display, determining, by the control unit, whether the height of the boom, the arm, or the bucket is close to the limit height.

13. The control method of claim 12, wherein when it is determined that the height of the boom, the arm, or the bucket is close to the limit height, the control unit outputs a second warning signal to the display, and
a warning image or a warning voice according to the second warning signal is different from a warning image or a warning voice according to the first warning signal.

14. The control method of claim 11, wherein in the detecting of the height of each of the boom, the arm, or the bucket, the control unit detects a maximum height in a boom cylinder pin bracket of the excavator, a maximum height in an arm cylinder pin bracket, a maximum height in a bucket link, and heights of a bucket bag and a bucket tip.
